(19) United States
(12) Patent Application Publication
(10) Pub. No.: US 2025/0088649 A1
(43) Pub. Date: Mar. 13, 2025

(54) SYSTEMS AND METHODS FOR ROBUST MULTI-VIEW IMAGE TRANSLATION FOR ROBOTICS

(71) Applicant: Honda Motor Co., Ltd., Tokyo (JP)

(72) Inventors: Jeremiah M. COHOLICH, Atlanta, GA (US); Karankumar Ashokbhai PATEL, San Jose, CA (US); Jinda CUI, San Jose, CA (US); Soshi IBA, Mountain View, CA (US)

(21) Appl. No.: 18/826,116

(22) Filed: Sep. 5, 2024

Related U.S. Application Data
(60) Provisional application No. 63/582,334, filed on Sep. 13, 2023.

(51) Int. Cl. H04N 19/42; H04N 19/136; H04N 19/20

(52) U.S. Cl. CPC H04N 19/42; H04N 19/136; H04N 19/20

(57) ABSTRACT

Systems and methods for multi-view image translation are provided. Images from multiple views of objects in a scene that includes robotic elements are encoded into the feature space. Encoded features are combined with positional encodings of the objects and proprioception data associated with robotic elements. The encoded features pass through an attention layer that processes the features in the feature space and outputs translated images. The attention layer removes robotic element features and restores missing object features in the translated images using object features associated with other camera views of the scene. Translated images are decoded into a desired output space.

This application claims the benefit of U.S. provisional patent application Ser. No. 63/582,334, filed Sep. 13, 2023, which is incorporated by reference in its entirety herein.

### BACKGROUND

Robotic systems often include imaging systems to assist in positioning and operating robotic elements to perform desired functions. During robotic operations, cameras and other imaging system elements may not consistently have unobstructed views of objects that are important to the robotic operations. For example, robotic elements may block portions of a view of a particular camera during some robotic operations. In another example, objects being manipulated by robotic elements may occlude the view of other objects during some robotic operations. Other disturbances may also interrupt or degrade the image capturing process during live operations, including but not limited to particulate accumulation on lenses or sensor elements, vibration-induced motion blur, lens flaring and other lighting-related issues due to bright sources of light, camera signal interruptions, and temporary power interruptions among other possible issues.

Robotic systems also may require image translation between different domains. Simulations of robotic operations may need to be translated from simulated images in a computer domain into real world images or vice versa. Various approaches have been devised to address image translation including the use of Generative Adversarial Networks (GAN) and Diffusion Models. Using GANs for image translation may require content-preservation loss processing such as cycle-consistency, multi-layer patch-wise contrastive loss, and consistency loss over outputs from object detectors or semantic segmentation networks. Such processing not only requires significant computational resources but may introduce processing delays that impact performance or usability in certain use cases.

### BRIEF DESCRIPTION

According to one embodiment, a system for multi-view image translation is provided. The system includes one or more image encoders, an image processor, and one or more image decoders. The image encoders encode images of different views of a common scene into feature-encoded images in a feature space. From the feature-encoded images, the image processor generates translated images that are also in the feature space. The processor removes at least one feature of a feature-encoded image and restores at least part of, or all of, a second feature in at least one of the translated images. The image decoders output some or all of the translated images in a desired output image format. The feature that is removed may be part of a robotic element. Robotic position data and robotic proprioception data may be associated with the feature-encoded images and used by the processor when generating the translated images and removing the feature. The processor may include a neural network such as a multi-headed self-attention network or a cross-image attention network.

According to another embodiment, a method for multi-view image translation is provided. The method includes receiving multiple sequences of images of different views of a scene from video sources and encoding the sequences of images into a feature space. The method also includes processing the sequences of images in the feature space and generating translated sequences of images, where the processing removes at least one feature and restores a second feature in one or more of the translated sequences of images. The method further includes decoding the translated sequences of images and outputting the decoded images as video sources.

According to yet another embodiment, a non-transitory computer readable storage medium is provided. The non-transitory computer readable medium may store instructions that, when executed by a computer having a processor, cause the computer to perform a method for multi-view image translation. The method includes receiving sequences of images of different views of a scene from video sources and encoding the sequences of images into a feature space. The method also includes processing the sequences of images in the feature space and generating translated sequences of images, where the processing removes at least one feature and restores a second feature in one or more of the translated sequences of images. The method further includes decoding the translated sequences of images and outputting the decoded images.

### BRIEF DESCRIPTION OF THE DRAWINGS

FIG. 1 is an exemplary component diagram of a system for robust multi-view image translation, according to one aspect.

FIG. 2A is an exemplary process flow of robust multi-view image translation, according to one aspect.

FIG. 2B is an image-oriented view of the exemplary process flow of robust multi-view image translation of FIG. 2A, according to one aspect.

FIG. 3 is an exemplary process flow of a method for robust multi-view image translation, according to one aspect.

FIG. 4 is an exemplary process flow of a first method of cross-image attention for robust multi-view image translation, according to one aspect.

FIG. 5 in an exemplary process flow of a second method of cross-image attention for robust multi-view image translation, according to one aspect.

FIG. 6 is an illustration of an example computer-readable medium or computer-readable device including processor-executable instructions configured to embody one or more of the provisions set forth herein, according to one aspect.

FIG. 7 is an illustration of an example computing environment where one or more of the provisions set forth herein are implemented, according to one aspect.

### DETAILED DESCRIPTION

The systems and methods presented herein for robust multi-view image translation provide a framework for combining information from multiple images taken of the same scene to provide robust image translation. By generalizing image data into a feature specific framework, the systems and methods may be agnostic to encoder and decoder architectures as well as the image generation pipeline, which may include various content-preservation loss algorithms. The feature specific framework may be used in rendering images from one domain to another domain, for example rendering images from a simulation into real-world images. The image translation framework enables generalization across domains without incurring high computational costs or large decreases in performance and processing delays.

Using multiple camera views and image processing techniques described herein the image translation framework also provides high robustness to visual disturbances, blocked or occluded views, and camera failures. Because image information from multiple viewpoints may be collectively shared in the described generalization process, missing information for any particular viewpoint may be recovered from the other viewpoints. For example, if one camera out of three fails or has part of its view blocked, a compensated image for that camera may be generated using information from the other two cameras to recover the parts of the view that is blocked.

The image translation framework operates by first capturing N images, where each of the N images represents an image of a common scene that is captured at the same time, or substantially same time, from one of N cameras, imaging sensors, or the like. Each of the N images is encoded into a feature space, for example using one or more suitable encoders that identify objects of interest associated with particular groups of pixels in each of the N images. The encoders may encode objects of interest similarly across each of the N images. The features in the feature space from each of N images are then processed in combination to generate processed features for each of the N images of the image space, with each generated feature being derived from the features appearing in some or all of the N image frames. The image translation framework may include custom attention mechanisms for combining feature information from multiple viewpoints and processing feature information into the processed features.

When a scene includes robots or robotic elements, the system may have access to data associated with robotic proprioception. Proprioception is generally defined as information about the state of the robot or robotic elements such as position, orientation, joint angles, velocities, acceleration, torques, and so forth. Proprioception data may be combined with the encoded image features and used by the systems and methods described herein to improve processing of the feature data.

The processed features may then be decoded by suitable decoders into the desired space for output. For example the processed features may be decoded into a set of N new images in a new space or in the original space captured by the cameras. In an example, a set of N images from a simulation may be encoded into the feature space; the features then may be combined and processed into a set of desired features of interest; and the processed images may then be decoded and output as a set of N real-world images. These operations may be repeated for each subsequent capture operation to generate N streams of processed images, one output for each original camera input. In an embodiment, the number of camera inputs and video stream outputs may be different. The processed features may be decoded and output into a desired output space, that may be the same or different from the space captured by the cameras.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.
“Agent” as used herein is a self-propelled machine that moves through or manipulates an environment. Exemplary agents may include, but is not limited to, robots, vehicles, or other self-propelled machines. The agent may be autonomously, semi-autonomously, or manually operated.
“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a bus that interconnects components inside an agent using protocols such as Media Oriented Systems Transport (MOST), Controller Area Network (CAN), Local Interconnect network (LIN), among others.
“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.
“Computer communication,” as used herein, refers to a communication between two or more communicating devices (e.g., computer, personal digital assistant, cellular telephone, network device, vehicle, computing device, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.
“Communication interface” as used herein may include input and/or output devices for receiving input and/or devices for outputting data. The input and/or output may be for controlling different agent features, which include various agent components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.
“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.
“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.
“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.
“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device, mobility device, or host.
“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.
“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.
“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.
“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.
“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.
“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

### I. System Overview

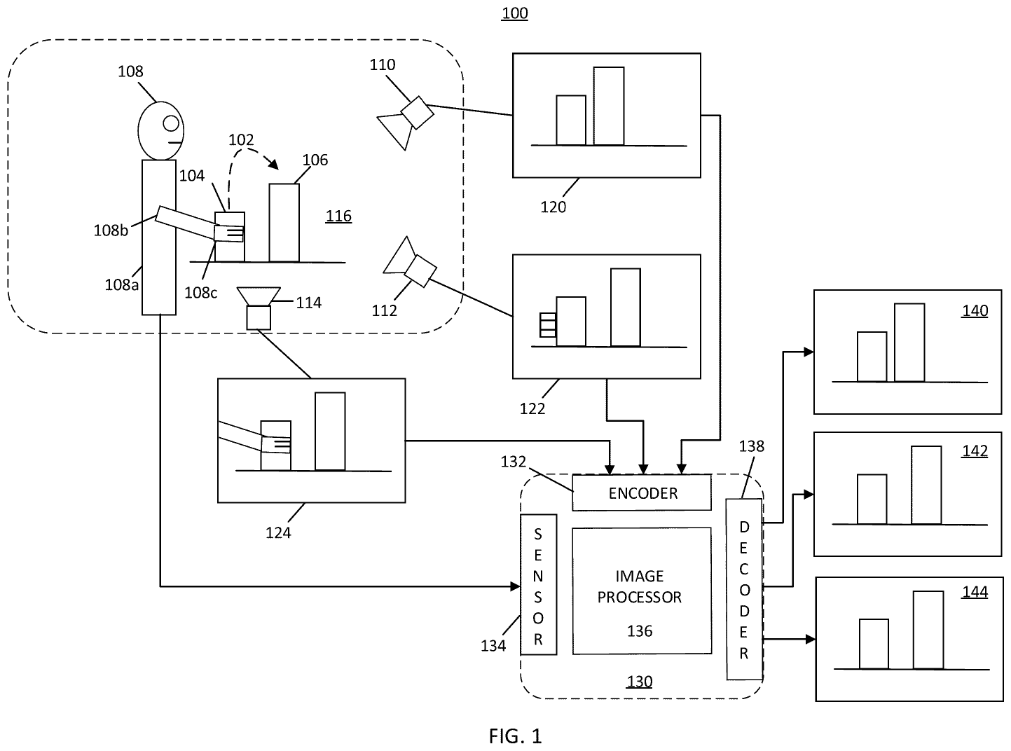

The drawings are for purposes of illustrating one or more exemplary embodiments and not for purposes of limiting the same. FIG. 1 is an exemplary component diagram of an operating environment 100 for robust multi-view image translation, according to one aspect. The operating environment 100 includes a simplified example robotic task 102 including a first object 104 and a second object 106 that are manipulated by a robot 108 having a body 108a, a first robotic element 108b, and a second robotic element 108c. Cameras 110, 112, and 114 capture images 120, 122, and 124 respectively of scene 116 that includes the robot 108, the first object 104 and the second object 106. Each of the images 120, 122, 124 capture different views of the scene 116 from different perspectives. In this simplified example, both image 120 and image 122 capture objects 104, 106 from slightly different perspectives. While image 124 includes object 106 in its entirety, robotic element 108c partially occludes the view of camera 114 from capturing all of object 104.

Images 120, 122, and 124 are input into a suitable computing platform 130. The computing platform 130 may comprise any suitable physical or cloud computing elements. The computing platform 130 may include one or more encoders 132 for encoding features in each of the images 120, 122, and 124 into a feature space, for example as further described below. The computing platform 130 may include one or more image processors 136 that perform image processing of the features. The computing platform 130 may include one or more decoders 138 for decoding features from the feature space into translated images 140, 142, 144 in a desired output space or domain. The input and output domains may be identical or different as required for the specific application. For example, original images 120, 122, 124 from a simulation may be processed in the above imaging framework and rendered into real-world translated images 140, 142, 144.

In an embodiment the images 120, 122, 124 are received by the computing platform 130 as streams of images, such as video, which are processed by the computing platform 130 and output as streams of translated images 140, 142, 144, such as video. The image streams or video may be in any suitable format, such as H.264 encoded video.

In an embodiment, the computing platform 130 includes a robotic sensor input 134 for receiving information about the state of the robot 108. For example the robotic sensor input 134 may receive proprioception information such as position, orientation, joint angles, velocities, acceleration, torques, and so forth of the robot 108. Proprioception data may be combined with the encoded image features and used by the image processor 136 for combining feature information from multiple viewpoints into new features as described in further detail below. The robotic sensor input 134 may receive the proprioception information from the robot 108 in any suitable data format, including but not limited to TCP/IP. Sensors may be any type of sensor, for example, tactile, acoustic, electric, environmental, optical, imaging, light, pressure, force, thermal, temperature, proximity, gyroscope, and accelerometers, among others. Furthermore, a single sensor may include multiple individual sensors and/or sensing components.

The robot 108 may be implemented as a part of an agent. The agent may be a robotic arm, a bipedal robot, a two-wheeled or four-wheeled robot, a vehicle, a self-propelled machine, or a part of an assembly line. The agent may be configured as a humanoid robot. The humanoid robot may take the form of all or a portion of a robot. For example, the humanoid robot may take the form of an arm coupled to a hand with fingers. The computing platform 130 may be implemented as part of the robot 108. In embodiments, the components and functions of the computing platform 130 may be implemented, for example, with other devices (e.g., a portable device) or another device connected via a network. The computing platform 130 may be capable of providing wired or wireless computer communications utilizing various protocols to send/receive electronic signals internally to/from components of the operating environment 100. Additionally, the computing platform 130 may be operably connected for internal computer communications via a bus (e.g., a Controller Area Network (CAN) or a Local Interconnect Network (LIN) protocol bus) to facilitate data input and output between the computing platform 130 and the components of the operating environment 100.

The computing platform 130 includes a processor, a memory, a data store, and a communication interface, which are each operably connected for computer communication via a bus and/or other wired and wireless technologies. The communication interface provides software and hardware to facilitate data input and output between the components of the computing device and other components, networks, and data sources, which will be described herein. Additionally, the computing platform 130 may include processing capability described in one or more modules. The image processor 136 may be implemented in part or in whole using one or more neural networks that implement machine learning which may include deep learning. Example neural networks include convolutional neural networks (CNN) and generative adversarial networks (GAN). Components of a neural network may include an input layer, an output layer, and one or more hidden layers, which may be convolutional filters.

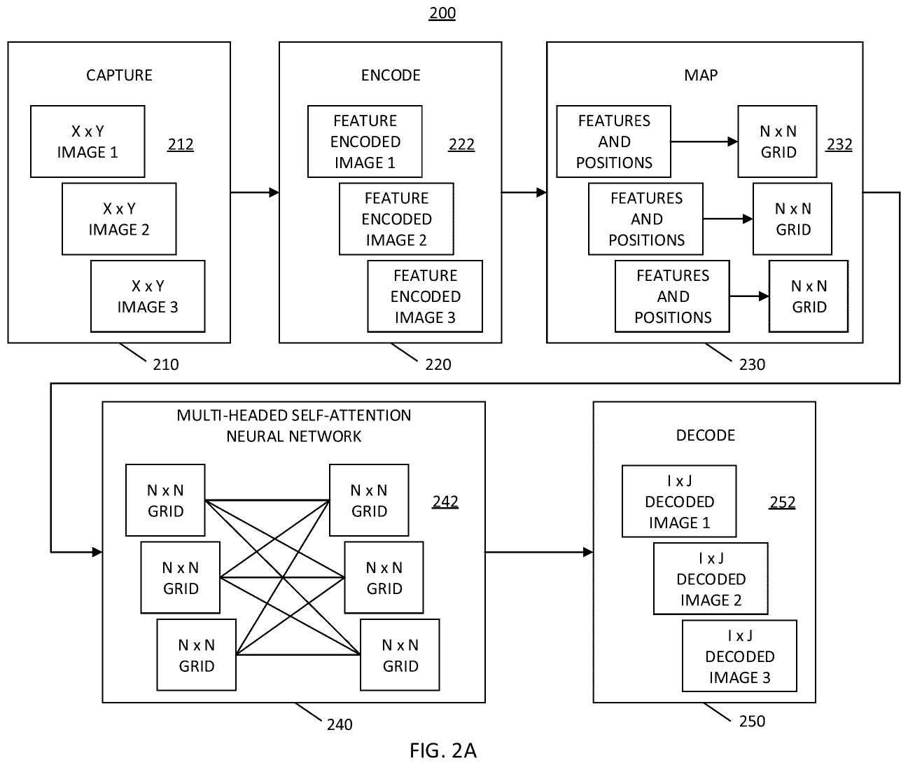

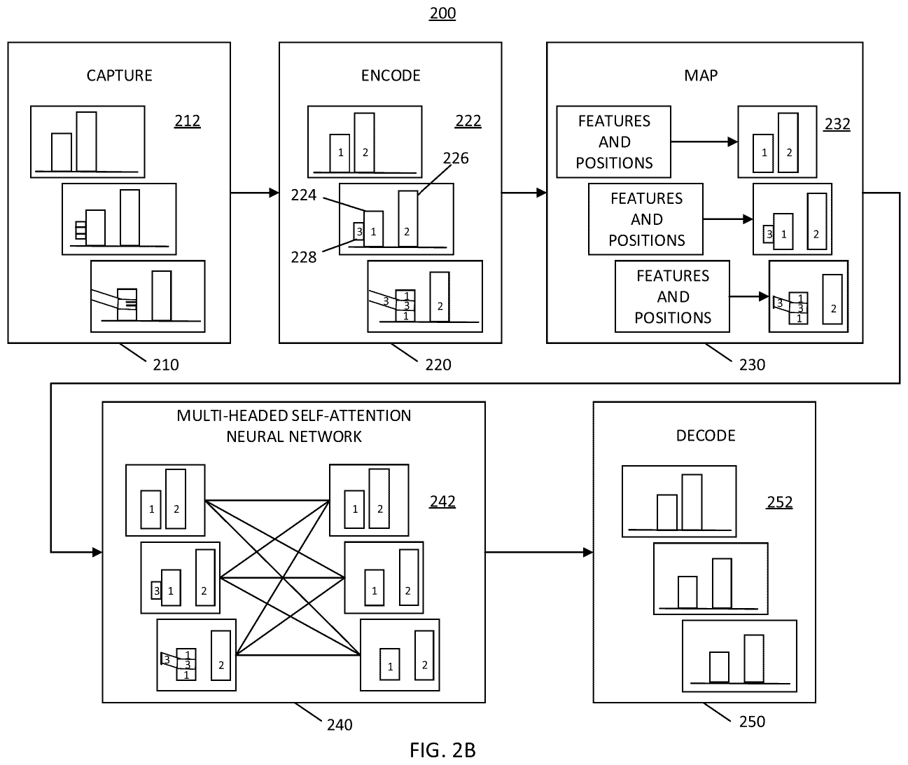

Referring to FIG. 2A, an exemplary process flow 200 of robust multi-view image translation is presented. At block 210, N images 212 from N camera views are captured or received from memory. At block 220, the N images 212 encoded by one or more suitable encoder(s). The encoder identifies features of interest in each of the N images 212 and encodes them as N encoded images 222. Any number of features may be identified by the encoders.

Referring also to FIG. 2B, a representation of the exemplary process flow 200 that uses the N images 120, 122, 124 of FIG. 1 is presented for purposes of illustrating the example operations of the process flow 200. For example, sample images 120, 122, 124 shown in FIG. 1 are illustrated as N captured images 212 in FIG. 2. The N encoded images 222 encoded at block 220 may include features 224, 226, and 228 that are associated with the first object, the second object, and portions of the robot respectively. In the N encoded images 222, each object or robotic element of the robot may comprise a specific region of associated pixels in the captured images 212. While each of the many pixels associated with an individual object may have a different RGB value, when mapped into the feature space each feature associated with a particular object would have a common feature value.

For example, all of the pixels associated with a feature identified as the first object 204 might be mapped to a common first feature value (for example feature 1), all of the pixels associated with the feature identified as the second object 206 might be mapped to a second feature value (for example feature 2), pixels associated with the feature identified as the robot 208 might be mapped to a third value (for example feature 3), and the remaining areas identified as background 202 might be mapped to a different value (not shown.) In this simplified example, the original images 212 from each of the N camera views may include an X by Y array of pixels, such as an 1920×1080 array of pixels, with each pixel having a potentially unique 24-bit RGB color value. The feature encoded images 222 in this example would have a 1920×1080 array of feature values, where each element of the array would be potentially mapped to just one of three objects, and therefore one of three values (1, 2, or 3), based on whether the particular element of the array is associated with the first object, the second object, or the robot.

The feature information may be encoded in any suitable way. For example, the feature data may have a feature depth of 8 bits, 16 bits, or any multiple or subset of bits. The encoding for the feature data may be word or bit-oriented. For example, a 8-bit feature depth may be capable of supporting 8 or 256 different features depending upon the encoding modality. In a first encoding modality using an 8-bit word, each pixel could be identified with exactly one of 256 unique features. In another example encoding modality, each feature may be associated with a particular bit such that an 8-bit feature depth could encode 8 different features.

In an embodiment, the feature encodings may be added to the image data to produce the feature encoded images 222. For example, a feature encoded image may be a 1920×1080 image where each pixel is 32-bits, where 24-bits remain as the original RGB encoded color data and 8 new bits are added for the feature data. In another embodiment, the feature encodings alone are used as the feature encoded images 222. For example, a feature encoded image 214 may be a 1920×1080 where each pixel is 8-bits representing only the feature information. In yet another embodiment, the feature encoded image data 214 includes both a 1920×1080 image with 24-bits of RGB information and a separate 1920×1080 image with 8-bits of feature information that are sent in separate data channels or a single interleaved data stream. Feature encoded images 222 for the N associated images 212 are passed to block 230.

In an embodiment, the operations of block 210 and block 220 may be combined to reduce computational operations and any associated storage and transfer of data. Blocks 210 and 220 are illustrated and described separately for generally describing operations but should not be construed as requiring separate discrete operations in practice.

At block 230, the features 224, 226, 228 of the feature encoded images 222 from block 220 may be mapped into a desired feature space. For example, each feature encoded image 222 may be encoded into an n×n grid 232. The features 224, 226, 228 may be positionally associated within the grid 232 in accordance with positional encodings of the objects in each of the feature encoded images 222.

In an embodiment, robot proprioception data such as position, orientation, joint angles, velocities, acceleration, and torques of robotic elements may be used to augment or generate positional encodings of features associated with a robot. Robot proprioception data may be used to identify occluded views of objects of interest in the images and associated feature encodings of those features in the feature space represented in the grid 232.

The features 224, 226, 228 in the feature space are mapped onto the grid 232 such that points in the grid 232 associated with the same object have the same feature value. Although each grid 232 is symbolically represented as an n×n grid 232 for purposes of illustration, the features 224, 226, 228 can be mapped onto one or more n×n grids, a grid of n×m size, grids of other suitable dimensions, point clouds, or other representations that allow the image processing system to identify and process common features between different images at block 240.

In an embodiment, the n×n grid 232 is an undersampled representation of features from the image data. For example, an original 1920×1080 pixel image with 24-bit RGB color depth may be mapped into a 500×500 grid in the feature space that uses just 8-bits of feature data. In other embodiments, the grid 232 may be oversampled, identically sampled in the feature space as the image space, sampled at a multiple or submultiple of the image space, or any other desired ratio or mapping.

The grid 232 may support any suitable or desired number of features. The grid 232 may have a feature depth of 8 bits, 16 bits, or any multiple or subset of bits. For example, the grid 232 may have an 8-bit feature depth capable of supporting up to 255 different identified features. In this feature space, a particular point in the grid 232 is mapped to exactly one unique feature, for example one of features 224, 226, 228. In another example feature space, each feature may be associated with a particular bit such that an 8-bit feature space could encode 8 different features, a 16-bit feature space could encode 16 features, and so forth. In this feature space, a particular point in the grid 232 could be identified with two or more overlapping features 224, 226, 228. In an embodiment, each feature may be mapped into its own grid 232. In this embodiment, the input N images at block 210 would result in N×k grids 232, where k represents the number of individual features identified by the encoder of block 220 or the number of individual features supported by the feature space.

Mapping the feature data into the grid 232 advantageously reduces the amount of memory necessary to represent and store scene information. Mapping the feature data into the grid 232 in the feature space advantageously simplifies the computational requirements necessary to process scenes represented in the feature space in real time. Mapping the feature data into the grid 232 advantageously facilitates the translation of images from one format to another, for example if the source images are of one resolution and bit depth while the output images are required to be in another resolution, bit depth, or encoding modality.

At block 240, the feature data in the grids 232 is passed through a multi-headed self-attention neural network to generate processed feature data 242. In an embodiment, the multi-headed self-attention neural network processes both intra-grid data and data between grids 232. In an embodiment, the multi-headed self-attention neural network includes temporal processing and uses feature data from grids 232 associated with previously taken images in determining the processed feature data. The multi-headed self-attention neural network recovers missing feature information in any grid 232 for any particular viewpoint from the feature data in the other grids 232 associated with the other viewpoints. The multi-headed self-attention neural network may restore object information for objects that are temporarily blocked, or that have portions of the object blocked, from one of the camera views. The multi-headed self-attention neural network may remove a feature that appears in only one of the grids 232 and replaces it with the feature that appears in the other grids 232, thus restoring the occluded feature. For example, if a robot blocks the view of an object in one of camera views, the multi-headed self-attention neural network can restore that camera's view of the object using the other camera views, removing the feature information associated with the occluding robotic element and replacing it with feature information about the object from the other camera views.

Advantageously the multi-headed self-attention neural network processes feature data associated with the grids 232 to generate the processed feature data 242 rather than the raw image data itself. Processing feature data in the grids 232 significantly reduces the processing complexity and decreases computational latency compared to processing raw image data, allowing the image translation framework to be deployed in real-time robotic applications. Further, the feature data and grids 232 allow the image translation framework to be agnostic with regard to the particular characteristics of the camera images themselves. This advantageously allows the image translation framework to be used with virtually any type of camera or image inputs with a suitable encoder.

At block 250, the processed feature data 242 is decoded into decoded images 252 using one or more suitable decoders, for example the decoders 138 of FIG. 1. The decoders translate features from processed feature data 242 in the feature space into translated images in a desired output space or domain, for example I by J sized RGB images as illustrated. The input and output domains may be identical or different as required for the specific application. For example, images from a simulation may be processed in the above imaging framework and rendered into real-world translated images. The images may be output as streams of images in a desired format, such as H.264 encoded video.

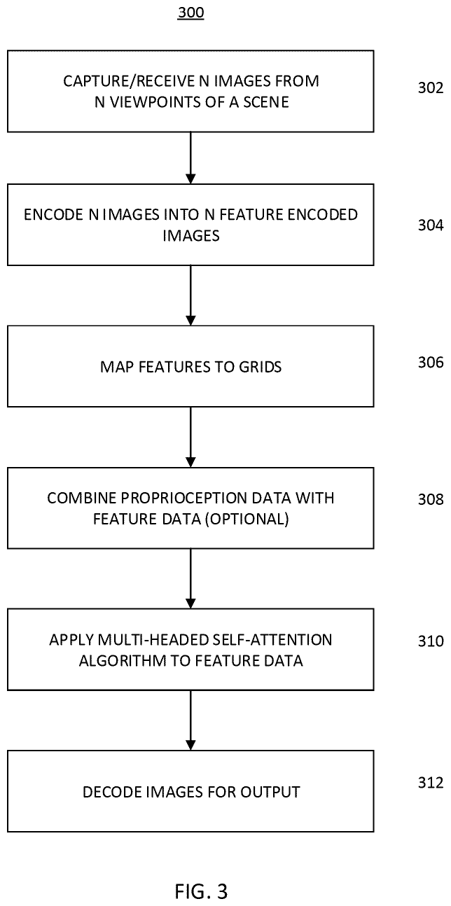

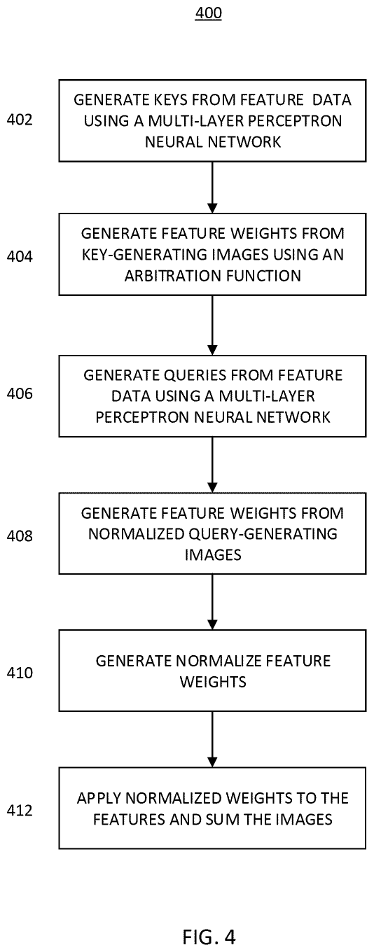

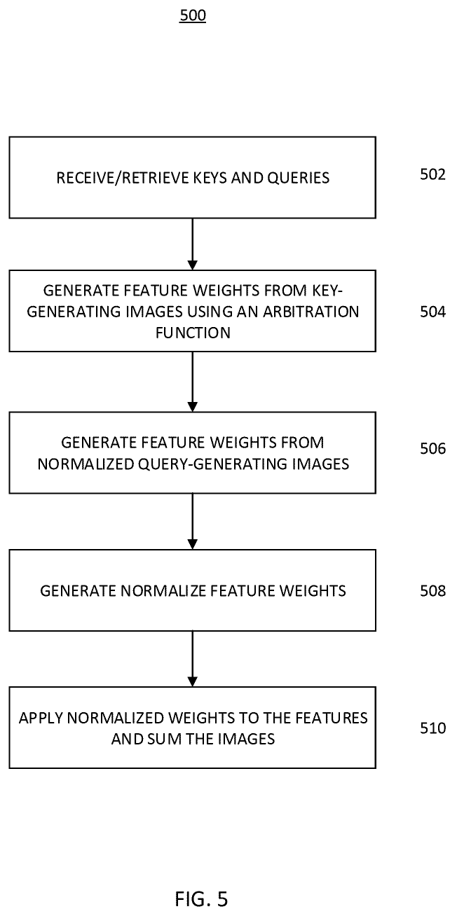

Detailed example methods of the robust multi-view image translation are presented below with respect to FIG. 3, FIG. 4, FIG. 5 and the associated detailed description.

### II. Methods for Multi-View Image Translation

Referring now also to FIG. 3, a method 300 for multi-view image translation will now be described according to an exemplary embodiment. FIG. 3 will also be described with reference to FIGS. 1, 2, and 4-7. For simplicity, the method 300 will be described as a sequence of processing steps, but it is understood that the steps of the method 300 may be organized into different architectures, blocks, stages, operations, and/or processes.

At block 302, the method 300 includes an image capture operation. A set of N images are captured of a scene by N imaging elements, such as cameras. In various embodiments, the cameras may be video cameras operating at 25 or 30 frames per second, or high speed cameras operating at 50 or 100 or higher frames per second. In other embodiments, the cameras can be still image cameras configured to capture individual images periodically or asynchronously. The N images from each of the cameras are captured at substantially the same time. The N images capture different perspectives of elements of the scene, for example different perspectives of robotic elements that are performing operations on objects in the scene.

At block 304, each of the N images from the set of N images is processed by an encoder configured to encode features in the feature space. The method may use a single encoder for each of the images or multiple encoders for multiple images. The encoders are operably configured to determine objects within each of the images that are associated with particular groups of pixels and assign each object to a unique enumerated feature. For example, an encoder determines that a first object in a first image is associated with a first group of pixels. The encoder assigned to feature 1, while a second object in the first image is assigned to feature 2. Determined objects in other images may be assigned to the same feature numbers. The encoding operation may be represented symbolically by the equation:

$$Zi = Enci ( Inpi ) \qquad ( 1 )$$

where Inp represents the input for the N images, Enc represents the encoder function, Z represents the features, and i is the index to the images which ranges from 1 to N.

At block 306, each of the features associated with objects may be mapped to points in grids, for example n×n grids. The grids may be of any suitable dimension, as described above with regard to FIG. 1 and the associated detailed description. For the purposes of exposition only, the grids in the present examples are each capable of supporting k unique features, where k is a whole number. Continuing with the example presented above, the first object in the first image may be assigned to feature 1 that is mapped to a subset of points in a first grid in approximately the same shape and relative position in the first grid as the first object is in the first image. Similarly, the second object is mapped to a second subset of points in the first grid also having approximately the same shape and relative position as the second object in the first image. Other objects in the first image may be assigned to other enumerated features and mapped to corresponding subsets of points in the first grid. Objects determined in each of the other N images may be similarly assigned to features and mapped to the other N grids associated with each of the other N images. The mapping operation may be represented symbolically by the equation:

$$Zi = concatenate ( Zi ; PEi ) \qquad ( 2 )$$

where Z represents the features, PE are the positional encodings in two dimensions for the n×n grid, and i is the index to the N images. After the encoding and mapping operations, each of the objects in the images have been encoded into the feature space.

At block 308, robotic proprioception data optionally may be included with the feature data. Example robotic proprioception data may include position, orientation, joint angles, velocities, acceleration, torques, etc. of robotic elements. The robotic proprioception data may be processed by a suitable function to render the multi-dimensional robotic proprioception data into a suitable representation for the two-dimensional grids. The mapping operation with robotic proprioception data would be represented symbolically by the equation:

$$Zi = concatenate ( Zi ; Pei ; g ( q ) ) \qquad ( 3 )$$

where Z represents the features, PE are the positional encodings for the grids, g represents the rendering function for the robotic proprioception data, q represents the robotic proprioception data, and i is the index for the images.

At block 310, the feature data is passed through a multi-headed self-attention neural network. In an embodiment, the multi-headed self-attention neural network processes both intra-frame data and data between frames. In an embodiment, the multi-headed self-attention neural network uses information from previous frames. Advantageously the multi-headed self-attention neural network processes feature data associated with the grids rather than the raw image data itself. Processing feature data significantly reduces the processing complexity and decreases computational latency compared to processing raw image data, allowing the image translation framework to be deployed in real-time robotic applications. Further, the feature data and grids allow the image translation framework to be agnostic with regard to the particular characteristics of the camera images themselves. This advantageously allows the image translation framework to be used with virtually any type of camera or image inputs with a suitable encoder.

The multi-headed self-attention neural network may recover missing information for any particular viewpoint from the other viewpoints. The multi-headed self-attention neural network may restore object information for objects that are temporarily blocked, or that have portions of the object blocked. For example, if one camera out of three fails or has some or part of its view blocked, a compensated image may be recovered using information from images associated with the other two cameras. In this way, the image translation framework provides high robustness to visual disturbances, blocked or occluded views, and camera failures. The multi-headed self-attention operation may be represented symbolically by the equation:

$$Z = MSA ( concatenate ( {\{ Zi \}}_{i = 1}^{N} ) ) \qquad ( 4 )$$

where Z represents the features, MSA is the multi-headed self-attention function, and i is the index for the images.

At block 312, the determined features are processed by a decoder configured to decode features into a desired output format or domain. The output format may be identical to the input format, or different from the input format as described above for FIG. 1 and the accompanying detailed description. The output format may comprise image streams or video in any suitable format, such as H.264 encoded video. The method may use a single decoder to generate each of the output images or may use multiple encoders for different image streams. The decoding operation may be represented symbolically by the equation:

$$Outi = Deci ( Z i ) \qquad ( 5 )$$

where Out represents the output images, Dec represents the decoder function, Z represents the features, and i is the index for the images which ranges from 1 to N.

Referring now also to FIG. 4, a first method 400 for cross-image attention is presented. In an embodiment, the operations of the method 400 for cross-image attention described below are used in place of the multi-headed self-attention algorithm of block 310 of FIG. 3. The multi-headed self-attention neural network of block 310 processes both intra-frame data and data between frames. However, for recovering missing image data using multiple different camera views, the disclosed cross-image attention algorithm focuses attention on features between different images rather than features within the same image as is the case for the multi-headed self-attention algorithm described above. The disclosed cross-image attention algorithm advantageously reduces parameter count and resources necessary for training and evaluation. The cross-image attention algorithm may use various multi-layer perceptron networks with any suitable number of hidden layers and dimensions.

At block 402, the cross-image attention algorithm generates keys from the feature data using a first multi-layer perceptron neural network. The key generating operation may be represented symbolically by the equation:

$$Ki = MLPK ( Zi ) \qquad ( 6 )$$

where K represents the generated key, MLP represents the multi-layer perceptron neural network, Z represents the features, and i is a first index for the images which ranges from 1 to N.

At block 404, the cross-image attention algorithm calculates weight of features from key-generating images using an arbitration function. The arbitration function maps features to a scalar. The weight generating operation may be represented symbolically by the equation:

$$wi = f ( Zi ) \qquad ( 7 )$$

where w represents the generated weight, f represents the arbitration function, Z represents the features, and i is the first index for the images.

At block 406, using a second index of the feature images, the cross-image attention algorithm generates queries from the feature data using a suitable multi-layer perceptron neural network. The query generating operation may be represented symbolically by the equation:

$$Qj = MLPQ ( Zj ) \qquad ( 8 )$$

where Q represents the generated query, MLP represents a second multi-layer perceptron neural network, Z represents the features, and j is a second index for the images which ranges from 1 to N. The cross-image attention algorithm generates queries for each of the feature images using the second index.

At block 408, also using the second index of images as in block 406, the cross-image attention algorithm normalizes feature values using the softmax function before calculating weights of features from query-generating images. The normalizing operation may be represented symbolically by the equations:

$$embedj = Norm ( Zj + softmax ( Qj \cdot {Ki}^{T} / \sqrt{k} ) Zj ) \qquad ( 9 )$$

$$embedj = Norm ( embedj + MLPj ( embedj ) ) \qquad ( 10 )$$

and the weighting operation may be represented by the equation:

$$wj = f ( embedj ) \qquad ( 11 )$$

where embed is the generated embedding, Norm represents a normalizing function, Z represents the features, Q represents the query, K is the generated key from block 402, MLP represents a third multi-layer perceptron neural network, and j is the second index of the images. The operations of block 408 are performed for each of the feature images using the second index. The cross-image attention algorithm normalizes values and generates weights for each of the feature images using the second index.

At block 410, the cross-image attention algorithm normalizes all of the generated weights generated in blocks 404 and 408 using the softmax function. The normalizing operation may be represented symbolically by the equation:

$$w 1 ; … ; wN = softmax ( w 1 ; … ; wN ) \qquad ( 12 )$$

where w represents the normalized weights, and softmax is the softmax function.

At block 412, the cross-image attention algorithm applies the normalized weights to the features and the images are summed. This operation may be represented symbolically by the equation:

$$Yi = wiZi + {\sum }_{j ϵ \{ 1 ; 2 ; … ; N \} \backslash \{ i \}} wj embedj \qquad ( 13 )$$

where Y represents the weighted and normalized output features, w represents the normalized weights, Z represents the features, i and j are the indexes, and embed is the generated embedding.

Referring now also to FIG. 5, a second method 500 for cross-image attention is presented. The second method 500 for cross-image attention is similar to the first method 400 for cross-image attention except the keys and queries are learned constants instead of being derived from inputs. For example, with fixed camera positions the keys and queries encode the geometric relationships between different viewpoints and are therefore constants that may be learned or provided to the algorithm.

At block 502, the keys and queries are provided to the cross-image attention algorithm. The keys and queries may be represented symbolically by the symbols K and Q.

At block 504, the cross-image attention algorithm calculates weight of features from key-generating images using an arbitration function. The arbitration function maps features to a scalar. The weight generating operation may be represented symbolically by the equation:

$$wi = f ( Zi ) \qquad ( 14 )$$

where w represents the generated weight, f represents the arbitration function, Z represents the features, and i is the first index for the images.

At block 506, using a second index of images, the cross-image attention algorithm normalizes feature values using the softmax function before calculating weights of features from query-generating images. The normalizing operation may be represented symbolically by the equations:

$$embedj = Norm ( Zj + softmax ( Qj \cdot {Ki}^{T} / \sqrt{k} ) Zj ) \qquad ( 15 )$$

$$embedj = Norm ( embedj + MLPj ( embedj ) ) \qquad ( 16 )$$

and the weighting operation may be represented by the equation:

$$wj = f ( embedj ) \qquad ( 17 )$$

where embed is the generated embedding, Norm represents a normalizing function, Z represents the features, Q represents the query provided in block 502, K is the key provided in block 502, MLP represents a multi-layer perceptron neural network, and j is the second index of the images. The operations in block 506 are performed for each of the feature images using the second index. The cross-image attention algorithm normalizes values and generates weights for each of the feature images using the second index.

At block 508, the cross-image attention algorithm normalizes all of the generated weights generated in blocks 504 and 506 using the softmax function. The normalizing operation may be represented symbolically by the equation:

$$w 1 ; … ; wN = softmax ( w 1 ; … ; wN ) \qquad ( 18 )$$

where w represents the normalized weights, and softmax is the softmax function.

At block 510, the cross-image attention algorithm applies the normalized weights to the features and the images are summed. This operation may be represented symbolically by the equation:

$$Yi = wiZi + {\sum }_{j ϵ \{ 1 ; 2 ; … ; N \} \backslash \{ i \}} wj embedj \qquad ( 19 )$$

where Y represents the weighted and normalized output features, w represents the normalized weights, Z represents the features, i and j are the indexes, and embed is the generated embedding.

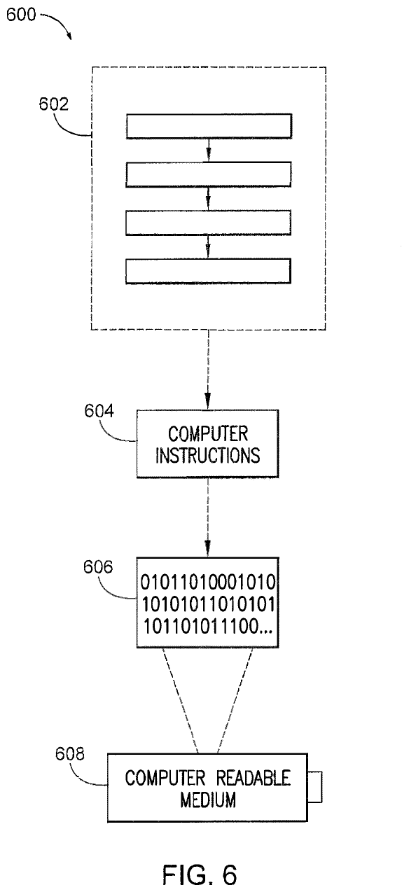

Referring now also to FIG. 6, in another aspect a computer-readable medium including processor-executable instructions configured to implement one aspect of the techniques presented herein. An aspect of a computer-readable medium or a computer-readable device devised in these ways is illustrated wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the method 300 of FIG. 3 and/or the method 400 of FIG. 4. In another aspect, the processor-executable computer instructions 604 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

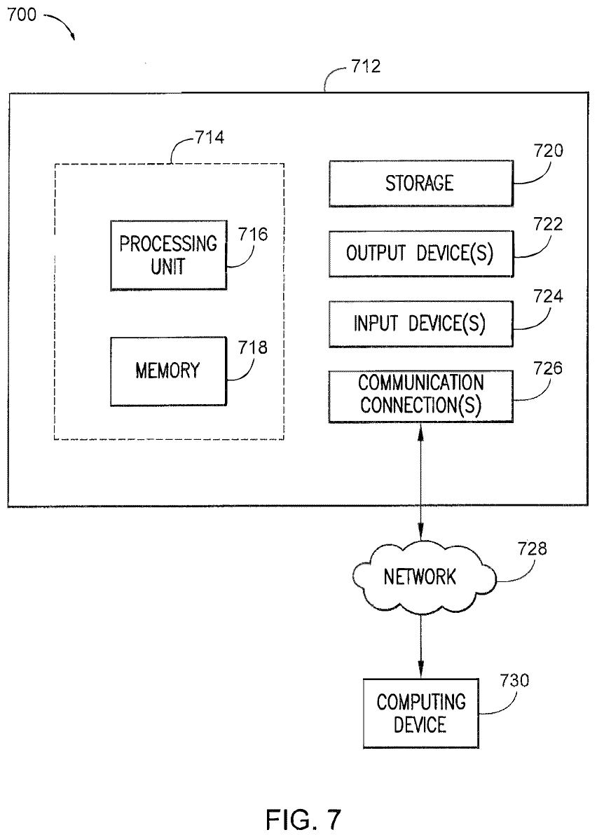

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, handheld or laptop devices, mobile devices, such as mobile phones, Personal Digital Assistants (PDAs), media players, and the like, multiprocessor systems, consumer electronics, embedded processors or controllers, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including an apparatus 712 configured to implement one aspect provided herein. In one configuration, the apparatus 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the apparatus 712 includes additional features or functionality. For example, the apparatus 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the apparatus 712. Any such computer storage media is part of the apparatus 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The apparatus 712 includes input device(s) 724 such as keyboard, mouse, pen, voice input device, touch input device, infrared cameras, video input devices, or any other input device. Output device(s) 722 such as one or more displays, speakers, printers, or any other output device may be included with the apparatus 712. Input device(s) 724 and output device(s) 722 may be connected to the apparatus 712 via a wired connection, wireless connection, or any combination thereof. In one aspect, an input device or an output device from another computing device may be used as input device(s) 724 or output device(s) 722 for the apparatus 712. The apparatus 712 may include communication connection(s) 726 to facilitate communications with one or more other devices 730, such as through network 728, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for multi-view image translation, comprising:
one or more image encoders that encode a plurality of images into feature-encoded images in a feature space, wherein an image and an associated feature-encoded image are associated with one of a plurality of image sources, and wherein each image source is associated with a different view of a common scene;
an image processor that processes the feature-encoded images to generate a plurality of translated images in the feature space, wherein the image processor removes at least one feature of a feature-encoded image when generating the translated images and restores, at least partially, a second feature in at least one of the translated images using second feature data from the other feature-encoded images; and
one or more image decoders that output one or more translated images in an output image format.

2. The system of claim 1, wherein the image processor associates positional encoding data of one or more robotic elements with the feature-encoded images, and
wherein the at least one feature that is removed by the processor is associated with a robotic element.

3. The system of claim 2, wherein the image processor further associates robotic proprioception data of the one or more robotic elements with the feature-encoded images.

4. The system of claim 1, wherein the processing includes passing at least the plurality of feature-encoded images through a neural network.

5. The system of claim 4, wherein the neural network is a multi-headed self-attention network that performs attention operations on features within a feature-encoded image and between the plurality of feature-encoded images.

6. The system of claim 4, wherein the neural network is a cross-image attention network that substantially performs attention operations on features between the plurality of feature-encoded images.

7. The system of claim 1, wherein a format of the feature-encoded images is different from at least one of the output image format and the received plurality of images.

8. A method for multi-view image translation, comprising:
receiving a first sequence of images of a first view of a scene from a first video source;
receiving a second sequence of images of a second view of the scene from a second video source;
encoding the first sequence of images of the first view into a third sequence of images encoded in a feature space;
encoding the second sequence of images of the second view into a fourth sequence of images encoded in the feature space;
processing the third sequence of images and the fourth sequence of images using a neural network to generate translated sequences of images in the feature space associated with the first view and the second view, wherein the processing removes a first feature of a feature-encoded image of the third sequence when generating the translated sequences of images and restores, at least partially, a second feature in at least one of the translated sequences of images from the fourth sequence of images;
decoding the translated sequences of images into a fifth sequence of images of the first view and a sixth sequence of images of the second view;
outputting the fifth sequence of images as the first video source; and
outputting the sixth sequence of images as the second video source.

9. The method of claim 8, wherein the scene includes a robotic element and an object, and wherein the robotic element is encoded as the first feature in the feature space and the object is encoded as the second feature in the feature space.

10. The method of claim 9, further comprising:
receiving a plurality of positional encodings of objects in the scene; and
combining the positional encodings of the objects with the associated features appearing in the images prior to processing images using the neural network.

11. The method of claim 9, further comprising:
receiving proprioception data associated with the robotic element; and
combining the proprioception data with the associated features appearing in the images prior to processing images using the neural network.

12. The method of claim 8, wherein the neural network is a multi-headed self-attention network that performs attention operations on features appearing within images and between features appearing in sequences of images associated with the first view and the second view.

13. The method of claim 8, wherein the neural network is a cross-image attention network that substantially performs attention operations between features appearing in sequences of images associated with the first view and the second view.

14. The method of claim 8, further comprising:
receiving one or more additional sequences of images of one or more additional views; and
encoding the additional sequences of images into the feature space,
wherein the processing operation using the neural network to generate translated sequences of images in the feature space includes processing the encoded additional sequences of images associatively with the third sequence of images and the fourth sequence of images.

15. A non-transitory computer readable storage medium storing instructions that when executed by a computer having a processor perform operations for multi-view image translation, comprising operations to:
receive a first sequence of images of a first view of a scene;
receive a second sequence of images of a second view of the scene;
encode the first sequence of images of the first view into a third sequence of images encoded in a feature space;
encode the second sequence of images of the second view into a fourth sequence of images encoded in the feature space;
process the third sequence of images and the fourth sequence of images using a neural network to generate translated sequences of images in the feature space associated with the first view and the second view, wherein the processing removes a first feature of a feature-encoded image of the third sequence when generating the translated sequences of images and restores, at least partially, a second feature in at least one of the translated sequences of images from the fourth sequence of images;
decode the translated sequences of images into a fifth sequence of images of the first view and a sixth sequence of images of the second view;
output the fifth sequence of images; and
output the sixth sequence of images.

16. The non-transitory computer readable storage medium of claim 15, wherein the scene includes a robotic element and an object, and wherein the robotic element is encoded as the first feature in the feature space and the object is encoded as the second feature in the feature space.

17. The non-transitory computer readable storage medium of claim 16, further comprising operations to:
receive a plurality of positional encodings of objects in the scene; and
combine the positional encodings of the objects with the associated features appearing in the images prior to processing images using the neural network.

18. The non-transitory computer readable storage medium of claim 17, further comprising operations to:
receive proprioception data associated with the robotic element; and
combine the proprioception data with the associated features appearing in the images prior to processing images using the neural network.

19. The non-transitory computer readable storage medium of claim 18, wherein the neural network is selected from the group consisting of:
a multi-headed self-attention network that performs attention operations on features appearing both within images and between sequences of images associated with the first view and the second view, and
a cross-image attention network that substantially performs attention operations between features appearing in sequences of images associated with the first view and the second view.

20. The non-transitory computer readable storage medium of claim 15, further comprising operations to:
receive one or more additional sequences of images of one or more additional views; and
encode the additional sequences of images into the feature space, and
wherein the processing operation using the neural network to generate translated sequences of images in the feature space includes processing the encoded additional sequences of images associatively with the third sequence of images and the fourth sequence of images.
